(19) United States
(12) Patent Application Publication
(10) Pub. No.: US 2025/0040736 A1
(43) Pub. Date: Feb. 6, 2025

(54) UTENSIL WITH CELL FRAME CONFIGURATION AND METHODS FOR MANUFACTURING SAME

(71) Applicant: KOLOR MAGNETIC (SHENZHEN) CO., LTD., Shenzhen (CN)

(72) Inventors: Ching Mou LEE, Hong Kong (CN); Chi Wai LEE, Hong Kong (CN)

(21) Appl. No.: 18/920,072

(22) Filed: Oct. 18, 2024

Related U.S. Application Data
(63) Continuation of application No. PCT/CN2023/089300, filed on Apr. 19, 2023.

(30) Foreign Application Priority Data
Apr. 19, 2022 (CN) 202230219265.6
Apr. 19, 2022 (CN) 202230219271.1
Apr. 19, 2022 (CN) 202230219285.3
Apr. 19, 2022 (CN) 202230219291.9

(51) Int. Cl. A47G 21/02; B29C 45/00; B29C 45/73; B29L 31/28

(52) U.S. Cl. CPC A47G 21/02; B29C 45/0053; B29C 45/73; A47G 2400/10; B29C 2045/0089; B29K 2995/006; B29L 2031/286

(57) ABSTRACT

The disclosed technology includes a biodegradable utensil and methods for manufacturing the same. The utensil can comprise a utility portion configured to manipulate a food item, a handle portion, and a transition portion disposed between the handle portion and the utility portion. The handle portion can comprise a body having a first thickness, thickness-reducing features each having a thickness less than the first thickness, and a bead extending along at least some of a length of the handle portion. The bead can be continuous and uninterrupted, can extend between a first thickness-reducing feature and a second thickness-reducing feature, and can have a second thickness that is greater than the first thickness.

### CROSS-REFERENCE TO RELATED APPLICATIONS

This application is a continuation of, and claims the benefit PCT/CN2023/089300, filed on Apr. 19, 2023, and entitled “Utensil with Cell Frame Configuration and Methods for Manufacturing Same,” which claims the benefit of, and priority to, Chinese Design patent application No. 202230219265.6, filed Apr. 19, 2022, and entitled “Spoon,” now Chinese Design Patent No. ZL202230219265.6; Chinese Design patent application No. 2022302192711, filed Apr. 19, 2022, and entitled “Spoon”; Chinese Design patent application No. 2022302192919, filed Apr. 19, 2022, and entitled “Spoon,” now Chinese Design Patent No. ZL2022302191.9; and Chinese Design patent application No. 2022302192853, filed Apr. 19, 2022, and entitled “Spoon,” now Chinese Design Patent No. ZL202230219285.3, the contents of which are hereby incorporated by reference in their entireties as if fully set forth herein.

### TECHNICAL FIELD

The systems and methods disclosed herein generally relate to a biodegradable eating utensil (e.g., spoon, fork, knife, spork), and more specifically to a bio-degradable utensil including a cell frame configuration for increased structural integrity, decreases material usage, increased biodegradability, and/or conforming to various government-defined standards.

### BACKGROUND

Plastic has become an incredibly pervasive substance in our society, with various plastics being used in a staggering high number of products across numerous industries. One area that has seen extensive use of plastics is the eating utensil industry, particularly with respect to single-use utensils. Nearly all single-use utensils are formed from plastic. Unfortunately, plastic utensils are typically incapable of efficient biodegradability (e.g., biodegradable in a reasonable period of time) and have thus become a contributing factor to pollution and other environmental concerns.

Efforts have more recently been directed toward implementing more environmentally friendly practices when designing and manufacturing utensils, especially single use utensils. Unfortunately, current environmentally friendly implementations fail to adequately preserve the structural integrity of the utensil. Additionally, current designs for environmentally friendly utensils typically lack the dimensionality, sizing, and/or weighting requirements to properly biodegrade in a normal disposal setting. To mitigate these issues, many government entities around the world have implemented weight, size, dimension, and other standards for properly defining “bio-degradable” utensils. Moreover, the manufacturing techniques currently used are generally more expensive than non-biodegradable utensil manufacturing alternatives, which can result in an increased cost for the consumer, thereby inhibiting widespread adoption of environmentally friendly options for utensils.

Therefore, there exists an unresolved need for a utensil that provides adequate structural integrity, biodegrades in a reasonable amount of time, and/or complies with applicable standards regarding the biodegradability of utensils (and/or the materials defining such utensils). Additionally, there exists an unresolved need for systems and methods for efficient and cost-effective manufacturing of environmentally friendly utensils on a mass scale.

### BRIEF SUMMARY OF THE DISCLOSURE

Briefly described, aspects of the present disclosure generally relate to a utensil apparatus with various configurations for enhanced biodegradation capabilities. Aspects of the present disclosure further include systems and methods for manufacturing the utensil. The utensil can include various cell frame configurations. The cell frame configurations of the utensil can help facilitate biodegradation of the utensil after disposal. The cell frame configurations of the utensil can help maintain weight requirements, size requirements, dimensional requirements, and/or any other legal requirements necessary for defining the utensil as “bio-degradable.” The cell frame configurations can increase the structural integrity of the utensil.

The utensil can include a handle portion, a utility portion, and a transition portion therebetween. That is to say, the handle portion can connect to the utility portion via the transition portion. The utility portion can include a fork configuration, a spoon configuration, a spork configuration (e.g., a utensil having the bowl-like shape as in a spoon combined with a plurality of tines as in a fork), a cutting or knife configuration, and/or any particular configuration useful for consuming and/or preparing food. As will be apparent to those having skill in the art, a user can manually manipulate the utensil using the handle portion and can thereby use the utility portion for any pertinent use case scenario (e.g., eating, cutting).

The handle portion, the transition portion, and the utility portion can include the cell frame configuration of the utensil. The cell frame configuration can include a plurality of apertures (e.g., near a distal end of the utensil) and/or a plurality of recesses (e.g., located along the handle portion, the transition portion, and/or the utility portion). For example, the handle portion can include various triangular apertures extending through the utensil. Alternatively or in addition, the handle portion, the transition portion, and a subsection of the utility portion can include various triangular recesses. The utensil can include a top surface and a bottom surface. The recesses can extend into the top surface and/or the bottom surface of the continuous body. The recesses can differ from the apertures in that the recesses do not completely extend through the utensil, whereas the apertures do extend through the corresponding portion of the utensil. The various recesses can be at a constant depth (e.g., relative the edges of the top surface or bottom surface immediately surrounding a corresponding recess), or the various recesses can be at two or more different depths. The recesses can have different depths depending on where a given recess is located along the utensil. For example, one or more recesses located on the utility portion can have a smaller depth than one or more recesses located on the handle portion. The varying depths of the recesses can help serve to reduce the amount of material at locations that typically incur lower levels of stress during use, while maintaining structural integrity at locations that typically incur increased levels of stress during use (e.g., the transition portion).

The disclosed utensil can include various types of cell frame configurations. For example, the cell frame configurations can include triangular configurations, circular configurations, hexagonal configurations, rectangular configurations, elliptical configurations, and/or any other applicable configurations. Stated otherwise, one or more apertures and/or one or more recesses can have a cross-sectional shape that is triangular, circular, hexagonal configurations, rectangular, or elliptical, as non-limiting examples.

The handle portion and/or the transition portion can include a bead. The bead can comprise an unbroken (e.g., by aperture or recess) line of material extending along a portion of the utensil. For example, the bead can extend at or near the central axis (e.g., central longitudinal axis) of the utensil. The bead can increase the structural integrity of the utensil by provide an increased thickness as compared to all of some of the rest of the utensil. For example, the bead can help provide structural support when applying pressure onto the utility portion and the transition portion. Alternatively or in addition, the bead can serve as a guide or channel (e.g., during manufacturing) to align and/or evenly distribute material to and/or through the cell frame configurations. Alternatively or in addition, the utensil can include two or more beads (e.g., two or more longitudinal beads located parallel to the central longitudinal axis of the utensil).

The utensil can comprise and/or be formed using any particular biodegradable material. As a non-limiting example, the utensil can consist of one or more biodegradable materials. For example, the utensil can comprise or be manufactured from Polyhydroxyalkanoates (PHA), Polylactic acid (PLA), Cellulose Acetate, and/or any other bio-based materials. The materials used to manufacture the utensil can include materials made from plants, fungi, microbes, and/or any other particular biodegradable material. As a non-limiting example, the utensil can be formed through an electric injection molding technique and/or any particular injection molding technique. As will be described more fully herein, the bead of the utensil can provide a channel path for facilitating or directing the flow of material into various portions of the utensil. For example, the bead can help reduce flow impediments, resistance, and/or friction within the mold and can increase material flow during injection.

These and other aspects, features, and benefits of the claimed innovation(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a perspective view of an example utensil, according to the disclosed technology;

FIG. 2A illustrates a bottom view of the example utensil, according to the disclosed technology;

FIG. 2B illustrates a top view of the example utensil, according to the disclosed technology;

FIG. 3 illustrates a cross-sectional view of the example utensil along a transverse cut line shown in FIG. 2B, according to the disclosed technology;

FIG. 4A illustrates a cross-sectional view of the example utensil along a longitudinal cut line shown in FIG. 1, according to the disclosed technology;

FIG. 4B illustrates a side view of the example utensil, according to the disclosed technology;

FIG. 5A illustrates a side view of a distal end of the example utensil, according to the disclosed technology;

FIG. 5B illustrates a side view of a proximal end of the example utensil, according to the disclosed technology;

FIG. 6 illustrates a perspective view of the example utensil, according to the disclosed technology;

FIG. 7 illustrates a bottom view of the example utensil, according to the disclosed technology;

FIG. 8A illustrates a cross-sectional view of the example utensil along a second longitudinal cut line shown in FIG. 6, according to the disclosed technology;

FIG. 8B illustrates a side view of the example utensil, according to the disclosed technology;

FIG. 9 illustrates a cross-sectional view of the example utensil along the transverse cut line shown in FIG. 7, according to the disclosed technology;

FIGS. 10A-10D illustrate various handle and utility configurations of the utensil, according to the disclosed technology;

FIG. 11 illustrates a flowchart of an example process for manufacturing the utensil, according to the disclosed technology; and

FIG. 12 illustrates an example mold for multiple utensils, according to the disclosed technology.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Throughout this disclosure, reference is made to “eating utensils” (or simply, “utensils”)—which should be understood to refer to any type of eating utensil, including (but not limited to) spoons, forks, sporks, or knives-unless the disclosure provided herein otherwise makes apparent that a specific element, feature, methodology, or implementation is limited to a specific type of utensil.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to a utensil apparatus with various aspects, elements, features, and/or configurations for enhanced biodegradation capabilities (e.g., as compared to existing designs). Aspects of the present disclosure further include systems and methods for manufacturing the utensil. The utensil can include various cell frame configurations. The cell frame configurations of the utensil can help facilitate biodegradation of the utensil after disposal. The cell frame configurations of the utensil can help satisfy applicable weight requirements, mass requirements, size requirements, dimensional requirements, and/or any other requirements (e.g., as imposed by a governing body for a particular jurisdiction) necessary for defining the utensil as “bio-degradable.” The cell frame configurations can increase the structural integrity of the utensil even with an overall decrease in material used, as described more fully herein.

The utensil can include a handle portion, a utility portion (e.g., a head), and a transition portion (e.g., a neck). The handle portion can be connected to the utility portion via the transition portion. The utility portion can include a fork configuration, a spoon configuration, a spork configuration (e.g., a spoon combined with a fork), a cutting or knife configuration, and/or any particular configuration used for consuming and/or preparing food. A user can manually manipulate the utensil via the handle portion and can thereby use the utility portion for any particular use case scenario (e.g., eating, cutting).

The handle portion, the transition portion, and the utility portion can include the cell frame configuration of the utensil. The cell frame configuration can include a plurality of apertures (e.g., near a distal end of the utensil) and/or a plurality of recesses (e.g., located along the handle portion, the transition portion, and/or the utility portion). For example, the handle portion can include various triangular apertures extending through the utensil. Alternatively or in addition, the handle portion, the transition portion, and a subsection of the utility portion can include various triangular recesses. The utensil can include a top surface and a bottom surface. The recesses can extend into the top surface and/or the bottom surface of the continuous body. The recesses can differ from the apertures in that the recesses do not completely extend through the utensil, whereas the apertures do extend through the corresponding portion of the utensil. The various recesses can be at a constant depth (e.g., relative the edges of the top surface or bottom surface immediately surrounding a corresponding recess), or the various recesses can be at two or more different depths. The recesses can have different depths depending on where a given recess is located along the utensil. For example, one or more recesses located on the utility portion can have a smaller depth than one or more recesses located on the handle portion. The varying depths of the recesses can help serve to reduce the amount of material at locations that typically incur lower levels of stress during use, while maintaining structural integrity at locations that typically incur increased levels of stress during use (e.g., the transition portion).

The disclosed utensil can include various types of cell frame configurations. For example, the cell frame configurations can include triangular configurations, circular configurations, hexagonal configurations, rectangular configurations, elliptical configurations, and/or any other applicable configurations. Stated otherwise, one or more apertures and/or one or more recesses can have a cross-sectional shape that is triangular, circular, hexagonal configurations, rectangular, or elliptical, as non-limiting examples.

The utensil can include or be formed using any particular biodegradable material. For example, the utensil can include or be manufactured from Polyhydroxyalkanoates (PHA), Polylactic acid (PLA), Cellulose Acetate, and/or any other bio-based materials. For example, the materials used to manufacture the utensil can include materials made from plants, fungi, microbes, and/or any particular biodegradable material. The utensil can be formed via an electric injection molding technique and/or any other injection molding technique. The bead can function as a channel or path for facilitating and/or directing the flow of material into various portions of the utensil (e.g., around apertures). For example, the bead can help reduce flow impediments, resistance, and/or friction within the mold and can increase material flow during injection.

### Exemplary Embodiments

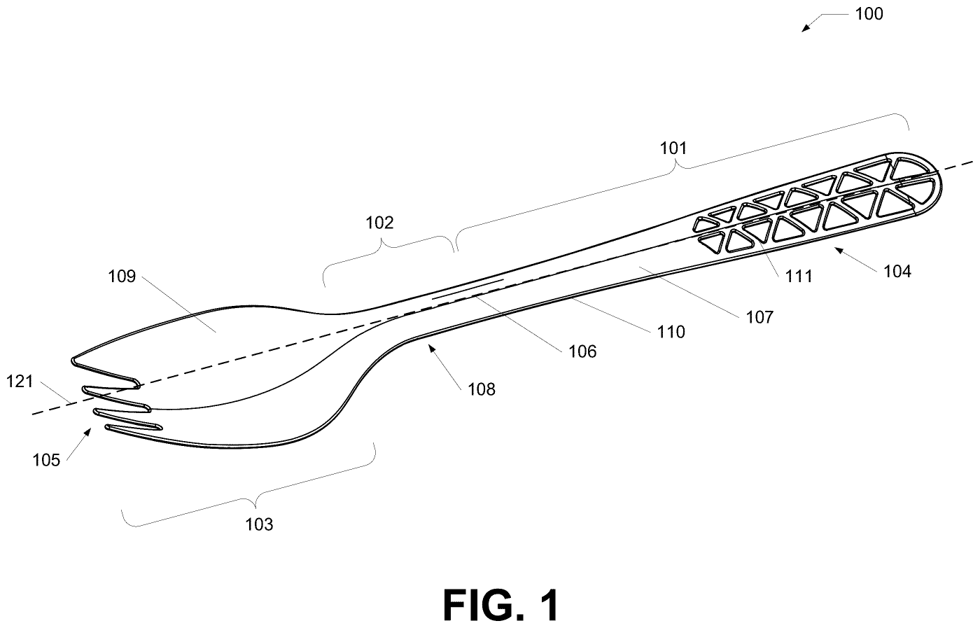

Referring now to the figures, for the purposes of provide examples and explanation of the fundamental elements, features, aspects, components, and processes of the disclosed systems and processes, reference is made to FIG. 1, which illustrates a utensil 100. As will be understood and appreciated, the utensil 100 shown in FIG. 1 represents merely one approach, configuration, or embodiment of the disclosed technology, and other aspects, elements, or features, can be used or included, as described more fully herein.

The utensil 100 can be a bio-degradable utensil for single-use or multi-use purposes. The utensil 100 can be defined as a hand-held tool used for cooking, eating, and/or cutting, as non-limiting examples. Although depicted in several figures as a spork (e.g., a utensil having a bowl-like spoon shape combined with the tines of a fork), the utensil 100 can be or include any other type of utensil. For example, the utensil 100 can be or include various kitchen or eating utensils such as a fork, a knife, a spoon, a spatula, and/or any particular type of utensil used for food consumption and/or food preparation. Furthermore, although primarily discussed throughout this disclosure in the context of the utensil 100, the various apparatuses, systems, methods, and/or processes discussed herein can be applied to any plastic object.

The utensil 100 can include a cell frame configuration 104. The cell frame configuration 104 can include various functionalities for the utensil 100. For example, the cell frame configuration 104 can provide structural integrity to various areas of the utensil 100. Alternatively or in addition, the cell frame configuration 104 can reduce the material necessary to form the utensil 100. In at least some instances, the reduction of material used to form the utensil 100 (e.g., via the cell frame configuration 104) can reduce the material cost of the utensil 100, reduce the waste generated when creating the utensil 100, increase the biodegradability of the utensil 100, and/or result in the utensil 100 satisfying applicable weight or thickness requirements for legal categorization as a “biodegradable” item.

The benefits provided by the various cell frame configurations 104 (and/or other aspects regarding the utensil 100) are greater than that of traditional utensils (e.g., utensils without a cell frame configuration 104). For example, the cell frame configuration 104 of the utensil 100 can increase the structural integrity of the utensil 100 while reducing the material weight and cost as compared to a utensil without a cell frame configuration 104. Alternatively or in addition, the cell frame configuration 104 can help reduce the mass, weight, and/or thickness of the utensil 100 to increase biodegradability as compared to utensils without a cell frame configuration 104.

The utensil 100 can include a handle portion 101, a transition portion 102, and a utility portion 103. The handle portion 101 can allow a user to hold and manipulate the utensil 100. The handle portion 101 can transition into, and/or be adjacent to, the transition portion 102. The transition portion 102 can demarcate a transition region between the handle portion 101 and the utility portion 103. The utility portion 103 of the utensil 100 can include a particular shape that facilitates an intended use. For example, the utility portion 103 can include a spork configuration. The spork configuration of the utility portion 103 can include one or more tines 105 for piercing food and/or any particular substance. Further continuing this non-limiting example, the spork configuration of the utility portion 103 can include a bowl 109 for scooping food and/or any particular substance. The utility portion 103 can include, for example, a knife configuration, a spoon configuration, a fork configuration, a spatula configuration, and/or any other configuration.

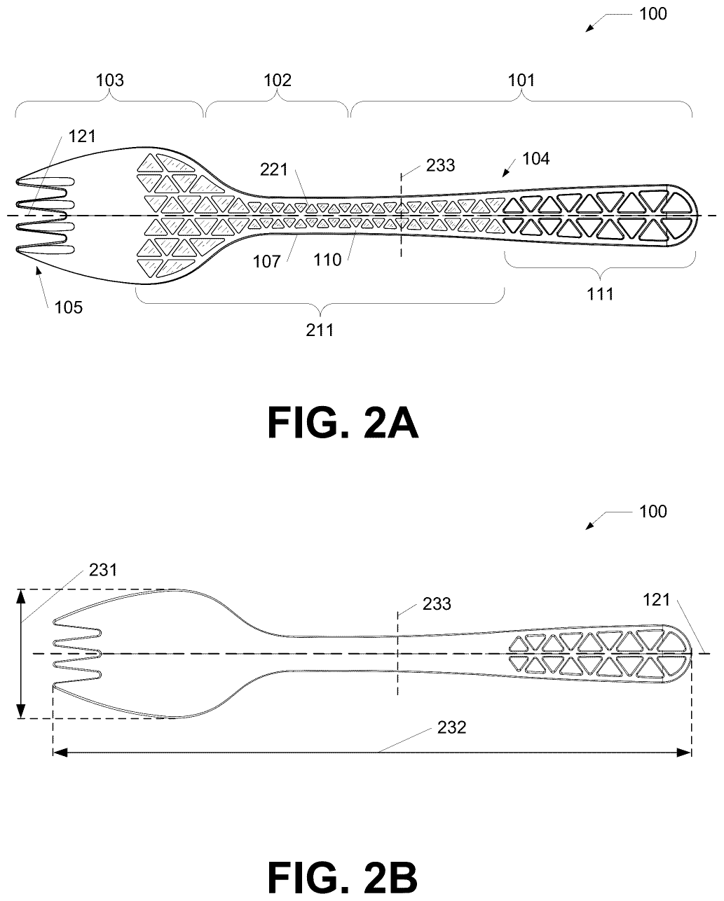

Although illustrated as being located on the handle portion 101, the cell frame configuration 104 can be distributed to any location on the utensil 100. For example, the cell frame configuration 104 can include one or more apertures 111 and/or one or more recesses 211 (scc, e.g., FIG. 2A). The apertures 111 can extend through the utensil 100. For example, the apertures 111 can extend through a top surface 107 and a bottom surface 110 of the utensil 100 to form a hole therethrough. The recesses 211 can partially extend through the utensil 100. For example, the recess 211 can extend through the bottom surface 110 and stop short from extending through the top surface 107 (or vice versa). The recesses 211 and/or the apertures 111 can reduce the mass, weight, sizing, and/or thickness of the utensil 100. By reducing the mass, weight, sizing, and/or thickness of the utensil 100 (e.g., via the cell frame configuration 104), the utensil 100 can maintain structural integrity while reducing cost and/or environmental impact.

The top surface 107 and/or the bottom surface 110 can be substantially smooth. For example, the top surface 107 and/or the bottom surface 110 can be substantially smooth at or along the utility portion 103 (e.g., to manage or reduce irritation when the utensil is used by a user).

The utensil 100 can be manufactured from or comprise Polyhydroxyalkanoates (PHA), Polybutylene succinate (PBS), Polybutylene adipate terephthalate (PBAT), Polylactic acid (PLA), Crystalized Polylactic acid (CPLA), Cellulose Acetate, and/or any other biodegradable materials. Alternatively or in addition, the utensil 100 can be manufactured from or comprise materials made from plants, fungi, microbes, and/or any particular bio-based material. Alternatively or in addition, the utensil 100 can be manufactured from or comprise non-toxic materials, easily recyclable materials, and/or any other material that bio-degrades over an acceptable period of time. Alternatively or in addition, the utensil can consist of PHA; PBS; PBAT; PLA; CPLA; Cellulose Acctation; any other biodegradable material; materials made from plants, fungi, microbes, or any particular bio-based material; non-toxic materials; easily recyclable materials; any other material that bio-degrades over an acceptable period of time; or any combination thereof.

The materials of the utensil 100 can vary in flexibility, rigidity, and strength. The material used for a given utensil 100 can be based at least in part on the target use of the utensil 100, which can at least partially dictate the material(s) most useful, cost-efficient, strong, or the like for the corresponding target use. For example, a knife utensil can be manufactured from or comprise PLA, as PLA is more rigid than some or all of the remaining aforementioned materials. Continuing this non-limiting example, the utensil 100 can comprise a composite material including PLA mixed with one or more other materials, which can reduce the brittleness associated with PLA.

The utensil 100 can be manufactured using a material with a low melt flow rate. For example, the melt flow rate of the material used to manufacture the utensil 100 can be approximately 15 grams per ten minutes (g/10 min). Alternatively or in addition, any material with any melt flow can be used in the formation of the utensil 100. The material used to form the utensil 100 can include a combination of distinct materials. As will be appreciate, combining materials for the utensil 100 can help achieve certain property characteristics of the utensil 100. For example, the material used for the manufacturing of the utensil 100 can include a compound material formed by mixing 82.5% of CPLA by mass with 17.5% of PBAT by mass. The compound material can include a range between approximately 15% and 20% of PBAT, where the remaining material of the compound material can be CPLA and/or one or more different materials. The material used to form the utensil 100 and the structural configuration (e.g., cell frame configuration 104) of the utensil 100 itself can improve the biodegradability of the utensil 100 in water, soil, and/or home environments.

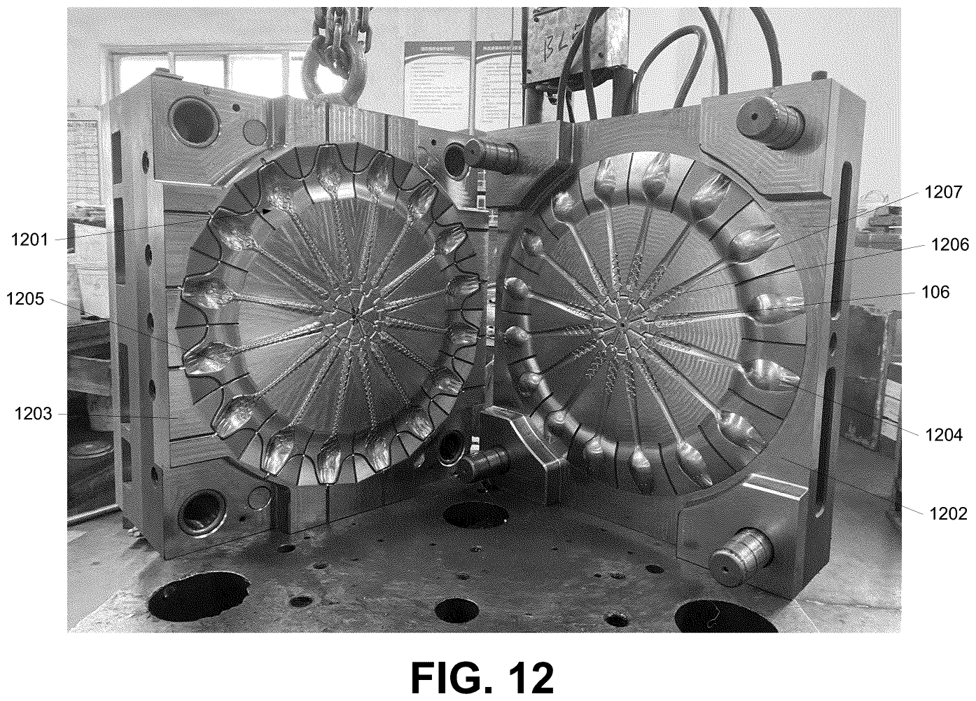

The utensil 100 can be manufactured via injection molding, thin wall injection molding, electric injection molding, and/or any other applicable manufacturing technique (e.g., any other molding technique). For example, the injection molding technique employed can include a hydraulic injection molding technique. The mold for the utensil 100 can include a mold cavity (see, e.g., FIG. 12). The mold cavity can be defined as a recess or negative space (or a series of recesses or negative spaces) into which a plastic (or any other material) can be introduced. Once the plastic or other material is cooled, cured, or otherwise hardened, the plastic or other material can form the utensil 100. The mold can include one or more cooling channels, through which chilled water or another refrigerant can flow to transport heat away from the injected material to thereby cool, cure, or otherwise harden the material to form the utensil 100.

The mold can include a channel extending in an at least partially longitudinal direction along at least some of the negative space corresponding to the utensil 100. The channel can ultimately form the bead 106 of the utensil, and the channel can facilitate and/or direct the flow of material during material injection to thereby direct and distribute material flow along the length of the negative space (e.g., the material flow can be easily flown along the entire length of the negative space) and the width of the negative space (e.g., the material flow can branch out laterally from the channel to thereby form the cell frame features of the utensil 100). The bead 106 can be substantially linear. The bead 106 can extend along at least a portion of the length of utensil 100. For example, the bead 106 can extend along a central longitudinal axis of the utensil 100 (e.g., along cut line 121). The bead 106 can extend along at least a portion of the handle portion 101, at least a portion of the transition portion 102, at least a portion of the utility portion 103, or any combination thereof. For example, the bead 106 can extend along some or all of the handle portion 101 and can extend along some of all of the transition portion 102. The bead 106 can have a thickness that is greater the one or more other portions of the utensil 100, such as the portions of the can be thicker than the surrounding portions of the utensil 100. As a non-limiting example, the bead 106 can reduce in thickness as the bead 106 gets closer to the distal end and/or proximal end of the utensil 100. During manufacturing, the bead 106 can serve as a pathway to help distribute material throughout the mold. For example, the bead 106 can promote material flow during thin gauge injection molding. As will be understood by those having skill in the art, with traditional systems and methods lacking a bead 106, it can be very difficult to evenly distribute material to every portion of the mold for creating the utensil 100. However, with the bead 106 disclosed herein can reduce the friction and pressure caused when injecting material into various areas of the mold (e.g., areas for forming the cell frame configurations 104), due to its increased thickness, for example. This can result in improved and/or even distribution of material throughout the mold for creating the utensil 100.

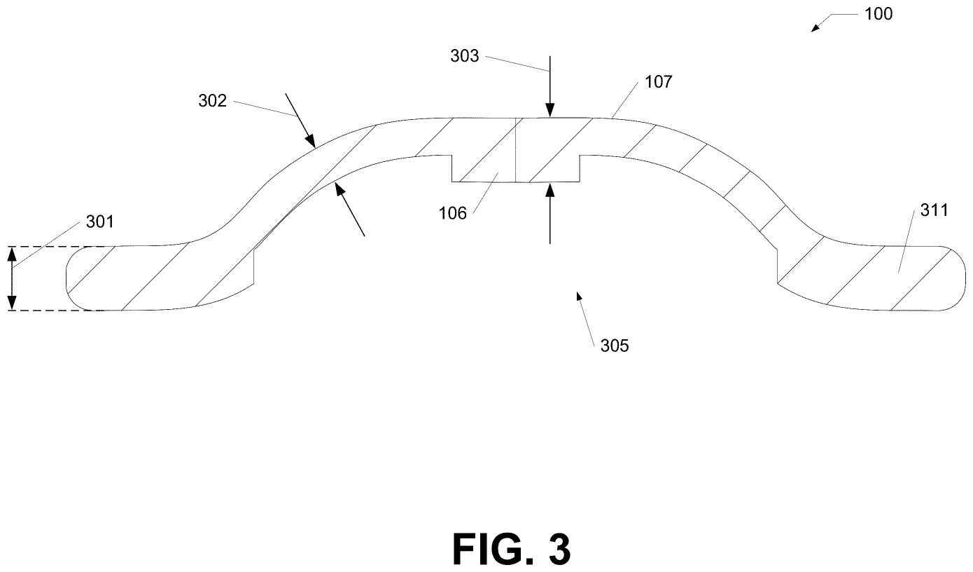

The utensil 100 can include one or more channels (e.g., of increased thickness as compared to surrounding or other areas of the utensil 100) that are not necessarily located along the central longitudinal axis of the utensil 100. The channels can extend at least partially in the longitudinal direction. One or more of the channels can be parallel to the central longitudinal axis. For example, as can be seen in FIG. 3, for example, the utensil 100 can include the bead 106, as well as side beads, which can be indicated by the utensil edges 311 having the first thickness 301. Alternative configurations and locations of the channels are contemplated herein. Further, the molds (e.g., negative spaces in the molds) corresponding to such beads are also contemplated herein.

Referring now to FIG. 2A, illustrated is a bottom view of the utensil 100, according to one embodiment of the present disclosure. The utensil 100 can include the cell frame configuration 104 extending from a proximal end of the utensil 100 to a distal end of the utensil 100. The proximal end of the utensil 100 can be defined as the outer or free end of the handle portion 101 (e.g., farthest from the tines 105, as illustrated). The distal end of the utensil 100 can be defined as the outer or free end of the utility portion 103 (e.g., nearest the tines 105, as illustrated). The cell frame configuration 104 can extend along at least a portion of the handle portion 101, along at least a portion of the transition portion 102, and/or along at least a portion of the utility portion 103. For example, the cell frame configuration 104 can extend along at least a portion of the handle portion 101, through the transition portion 102, and along a portion of the utility portion 103. The cell frame configuration 104 can extend to (or be located at) any particular location of the utensil 100.

The cell frame configuration 104 can include multiple subsections. Each subsection can include only a specific type of cell frame feature (i.e., an aperture 111 or a recess 211), a different pattern or configuration of apertures 111 and/or recesses 211, different shapes of apertures and/or recesses 211, different sizes of apertures 111 and/or recesses 211, recesses 211 of different depths, or the like. As explained elsewhere herein, the recesses 211 can differ from the apertures 111 in that the recesses 211 form a depression in the utensil 100 but do not form a through-hole in the utensil 100. The shapes 221 can include any polygon, rounded shape, and/or any other shape. For example, the shapes 221 can include a triangular shape, a rectangular shape, a square shape, a pentagonal shape, a hexagonal shape, a circular shape, an elliptical shape, a tear drop shape, any other shape, or a combination thereof. The shapes 221 of the cell frame configuration 104 can be selected to enhance the structural integrity of the utensil 100. For example, one or more triangular shapes 221 can be arranged such that each adjacent triangle minimizes the space between one another (e.g., in an alternating fashion such that a point of a given triangle points toward the bead 106 and a point of either adjacent triangle points away from the bead 106). By minimizing the space between each adjacent triangular shapes 221, the utensil 100 can include less material and weight/mass while still provided adequate structural integrity.

By including recesses 211, the cell frame configuration 104 can increase structural integrity in certain areas (e.g., as compared to areas in which apertures 111 are located) while still reducing the amount of material used in those areas. For example, recesses 211 located in or on the transition portion 102 can include substantially more material within the shapes 221 (e.g., the utensil 100 can have a greater thickness at those locations) to increase the structural integrity of the transition portion 102. The apertures 111 can exclude or omit material from within the shapes 221. For example, apertures 111 can be located along the proximal end of the handle portion, as this area of the utensil 100 typically incurs the least amount of stress during use. Though the apertures 111 lack material within their respective shapes 221, the configuration of the shapes 221 can nonetheless help distribute the stresses and forces experienced by the handle portion 101 (or any other portion or area of the utensil 100, such as the transition portion 102 and/or the utility portion 103) during use. The recesses 211 can include a variable amount of material within the shapes 221. By varying the amount of material within the shapes 221, the recesses 211 can maximize structural integrity of the utensil 100 while minimizing the excess material cost for reinforcing areas that do not require more reinforcement.

Referring now to FIG. 2B, illustrated is a top view of the utensil 100, according to one embodiment of the present disclosure. The utensil 100 can include a first width 231, a first length 232, and a first cut line 233. The first width 231 can be at least approximately 20.0 mm, between approximately 20.0 mm and approximately 40.0 mm, between approximately 20.0 mm and approximately 25.0 mm, between approximately 25.0 mm and approximately 30.0 mm, approximately 28.575 mm, approximately 31.75 mm, between approximately 30.0 mm and approximately 35.0 mm, at least approximately 34.925 mm, between approximately 35.0 mm and approximately 40.0 mm, and/or less than approximately 40 mm. The first length 232 can be at least approximately 130.0 mm, between approximately 130.0 mm and approximately 200.0 mm, between approximately 130.0 mm and approximately 140.0 mm, approximately 133.35 mm, approximately 139.7 mm, between approximately 140.0 mm and approximately 150.0 mm, approximately 152.4 mm, between approximately 150.0 mm and approximately 160.0 mm, between approximately 160.0 mm and approximately 170.0 mm, approximately 177.8 mm, between approximately 170.0 mm and approximately 180.0 mm, between approximately 180.0 mm and approximately 190.0 mm, approximately 190.5 mm, between approximately 190.0 mm and approximately 200.0 mm, or less than approximately 200.0 mm. The utensil 100 can weigh at least 1.0 gram (g), between approximately 1.0 mm and approximately 6.0 g, between approximately 1.0 mm and approximately 2.0 g, between approximately 2.0 mm and approximately 3.0 g, approximately 2.5 g, approximately 3.0 g, between approximately 2.5 mm and approximately 3.0 g, between approximately 3.0 to 4.0 g, approximately 3.4 g, approximately 4.0 g, between approximately 3.4 mm and approximately 4.0 g, between approximately 3.0 mm and approximately 4.0 g, between approximately 4.0 mm and approximately 5.0 g, approximately 3.6 g, approximately 4.4 g, between approximately 3.6 mm and approximately 4.4 g, between approximately 5.0 mm and approximately 6.0 g, or less than approximately 6.0 g. For example, a medium weight utensil 100 can include a first length ranging between approximately 133.35 mm and approximately 152.4 mm, a first width of approximately 28.575 mm, and a weight ranging between approximately 2.5 grams and approximately 3.0 grams. In another non-limiting example, a medium-heavy weight utensil 100 can include a first length ranging between approximately 139.7 mm and approximately 177.8 mm, a first width of approximately 31.75 mm, and a weight ranging between approximately 3.4 grams and approximately 4.0 grams. In yet another non-limiting example, a full-size utensil 100 can include a first length ranging between approximately 139.7 mm and approximately 190.5 mm, a first width of approximately 34.925 mm, and a weight ranging between approximately 3.6 grams and approximately 4.4 grams. The utensil 100 can have any combination of weight/mass, first width 231, and first length 232.

Referring now to FIG. 3, illustrated is a first cross section view along the first cut line 233 of the utensil 100. The first cross section of the utensil 100 can illustrate multiple thicknesses across the width of the utensil 100. For example, the utensil 100 can include a first thickness 301, a second thickness 302, and a third thickness 303. The first thickness 301 can be the thickness of or at a utensil edge 311. The utensil edge 311 can help prevent the utensil 100 from rocking or tipping when placed on a flat surface, can create rounded edges to increase comfort of the utensil 100 while holding, and can help the utensil 100 to nest with another utensil 100 when stacked. The first thickness 301 can be at least approximately 0.3 mm, between approximately 0.3 mm and approximately 2.0 mm, between approximately 0.3 mm and approximately 0.6 mm, approximately 0.6 mm, between approximately 0.6 mm and approximately 1.5 mm, between approximately 1.5 mm and approximately 2.0 mm, or less than approximately 2.0 mm. The second thickness 302 can be indicative of the thickness of a recess 211, a thickness of the curved surface 312, or a combination thereof. The second thickness 302 can be at least 0.0 mm (e.g., in the case of an aperture 111), at least approximately 0.05 mm, between approximately 0.0 mm and approximately 0.6 mm, between approximately 0.1 mm and approximately 0.3 mm, approximately 0.35 mm, between approximately 0.3 mm and approximately 0.6 mm, or less than approximately 0.6 mm. The second thickness 302 can vary throughout the utensil 100. For example, at the apertures 111, the second thickness 302 can be 0.0 mm (i.e., no material). In another non-limiting example, the second thickness 302 can vary at the recesses 211. For example, a first recess 211 can have a second thickness of 0.2 mm, while a second recess can have a second thickness of 0.35 mm. The third thickness 303 can be the thickness of the bead 106. The third thickness 303 can be at least approximately 0.3 mm, between approximately 0.3 mm and approximately 2.0 mm, 0.3 mm and approximately 0.6 mm, approximately 0.6 mm, between approximately 0.6 mm and approximately 1.5 mm, between approximately 1.5 mm and approximately 2.0 mm, or less than approximately 2.0 mm. The first thickness 301, the second thickness 302, and a third thickness 303 can vary based on the expected structural requirements of the utensil 100.

The curved surface 312 can at least partially form a utensil recess 305. The utensil recess 305 can function to help stack and store the utensil 100. For example, when stacking a first utensil 100 on top of a second utensil 100, the top surface 107 of the second utensil can nest into (e.g., at least partially insert into) the utensil recess 305 of the first utensil 100. Enabling the utensils 100 to nest one atop the other can help reduce material requirements for the utensils 100, as well as space requirements for packaging and shipping of the utensils 100.

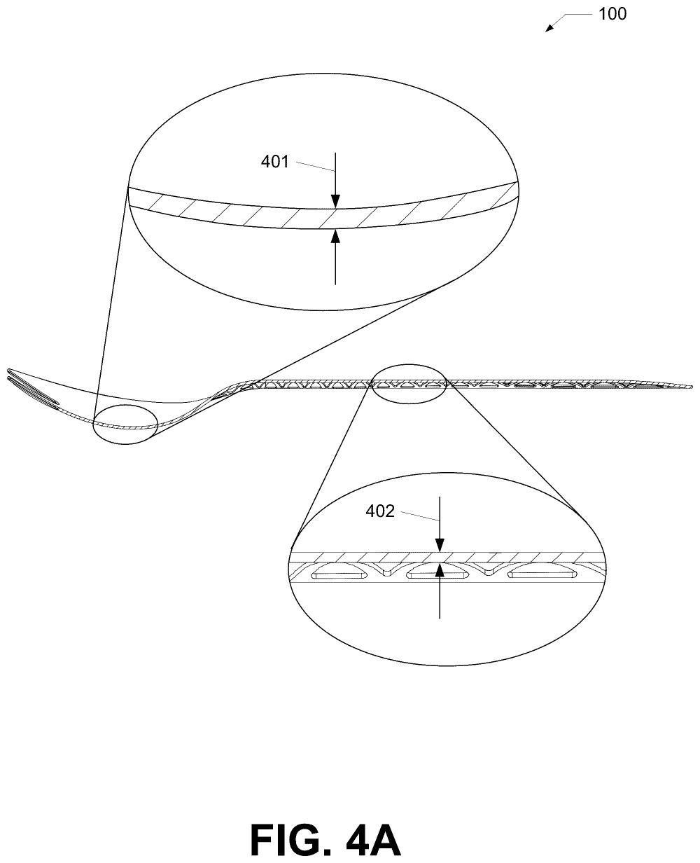

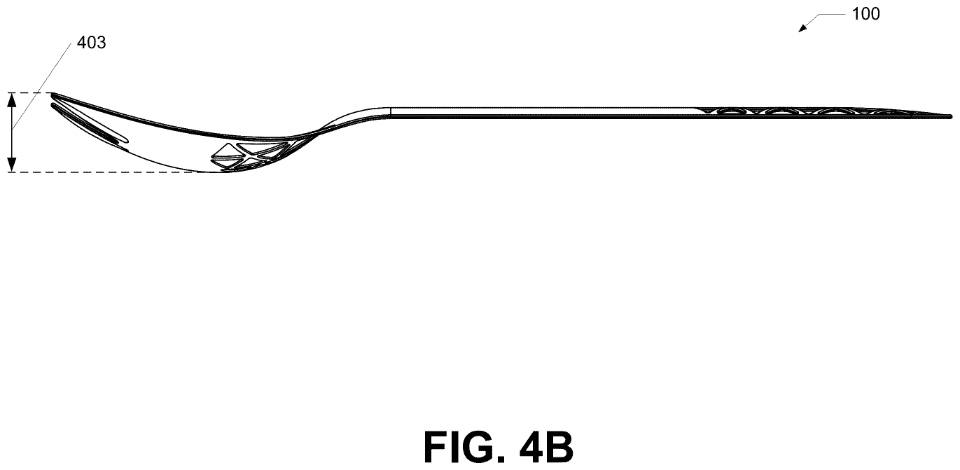

Referring now to FIG. 4A, illustrated is cross-sectional view of the utensil 100 taken along the second cut line 121, as well as a magnified view of a portion thereof. The utensil 100 can include a utility portion thickness 401 and a handle portion thickness 402. The handle portion thickness 402 can be at least approximately 0.3 mm, between approximately 0.3 mm and approximately 2.0 mm, between approximately 0.3 mm and approximately 0.6 mm, approximately 0.6 mm, between approximately 0.6 mm and approximately 1.5 mm, between approximately 1.5 mm and approximately 2.0 mm, or less than approximately 2.0 mm. The utility portion thickness 401 can be at least approximately 0.3 mm, between approximately 0.3 mm and approximately 2.0 mm, 0.3 mm and approximately 0.6 mm, approximately 0.6 mm, between approximately 0.6 mm and approximately 1.5 mm, between approximately 1.5 mm and approximately 2.0 mm, or less than approximately 2.0 mm. The handle portion thickness 402, the utility portion thickness 401, the first thickness 301, the second thickness 302, the third thickness 303, and/or any particular thickness can vary based on the type of material used. The thickness of any given portion of the utensil 100 can vary based on the structural requirements of the utensil 100. The utility portion thickness 401 and the handle portion thickness 402 can have equal or different thicknesses.

Referring now to FIG. 4B, illustrated is a side view of the utensil 100. The utensil 100 can have a utility height 403. The utility height 403 can refer to, for example, the distance between a lowermost point of the utility portion to an uppermost point of the utility portion 103 (e.g., when the handle portion 101 is parallel to ground or another reference surface). The utility height 403 can be at least approximately 5.0 mm, between approximately 5.0 mm and approximately 20.0 mm, between approximately 5.0 mm and approximately 10.0 mm, between approximately 10.0 mm and approximately 15.0 mm, approximately 13.26 mm, 1 between approximately 5.0 mm and approximately 20.0 mm, or less than approximately 20.0 mm.

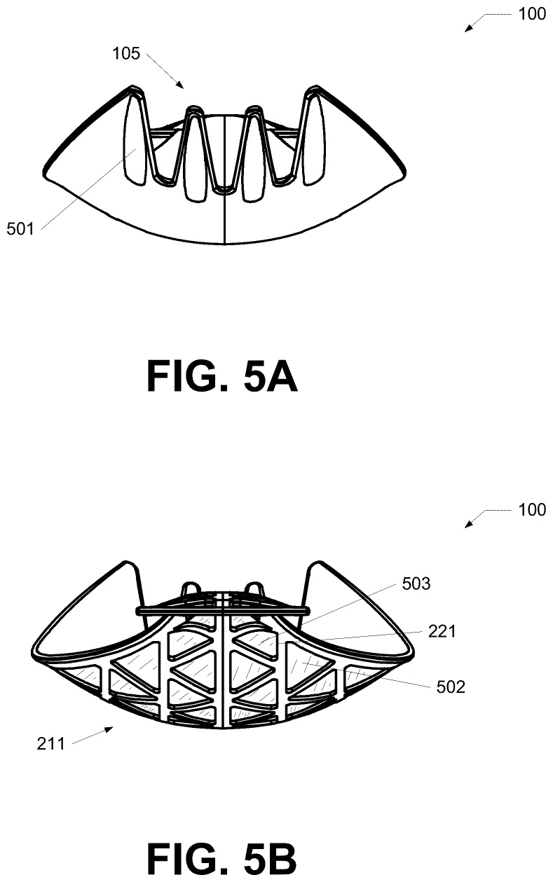

Referring now to FIG. 5A, a side view from the distal end of the utensil 100 is illustrated. The tines 105 of the utensil 100 can include one or more reinforcing structures 501. The reinforcing structures 501 can include extra material applied to the tines 105 (e.g., have a greater thickens than surrounding areas or portions of the tines 105) to increase the structural integrity of the tines 105. For example, the reinforcing structures 501 can reduce the likelihood the tines 105 break or bend during use.

Referring now to FIG. 5B, a side view from the proximal end of the utensil 100 is illustrated. The utensil 100 can include a first recess 502 and a second recess 503. The recesses 211 can include the first recess 502 and the second recess 503. The first recess 502 and the second recess 503 can have different amounts (e.g., thicknesses) of materials within their respective shapes 221. By varying the amount of material within the first recess 502 and the second recess 503, the utensil 100 can increase structural integrity at the critical locations (e.g., transition portion 102) and reduce material use in areas that require less structural integrity. For example, the second recess 503 may experience more stress and greater forces during use than the first recess 502. Continuing this non-limiting example, the second recess 503 can include more material (e.g., have a greater thickness) within its respective shape 221 as compared to the first recess 502.

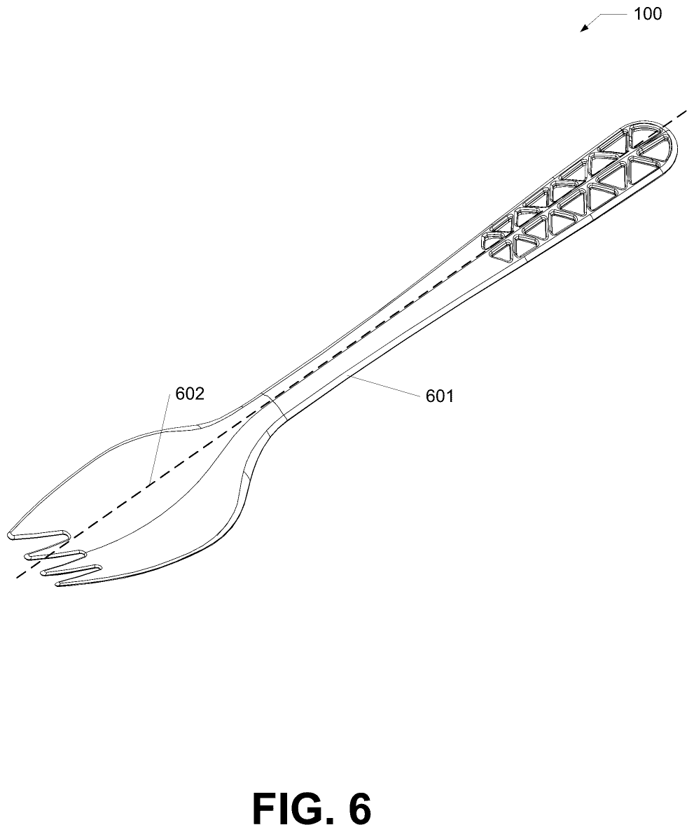

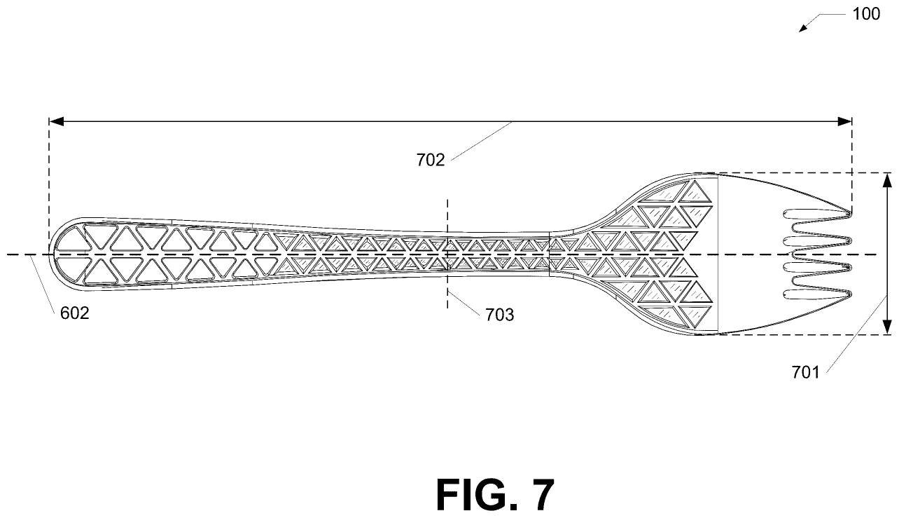

Referring now to FIG. 6, illustrated is a second perspective view of the utensil 100. The utensil 100 can include a rounded edge 601. The rounded edge 601 can improve the ergonomics of the handle portion 101, as a non-limiting example. The rounded edge 601 can extend around some or all of the entire border of the utensil 100.

Referring now to FIG. 7, illustrated is a second bottom view of the utensil 100. The utensil 100 can include a second width 701 and a second length 702. The second width can be at least approximately 20.0 mm, between approximately 20.0 mm and approximately 40.0 mm, between approximately 20.0 mm and approximately 25.0 mm, between approximately 25.0 mm and approximately 30.0 mm, approximately 28.575 mm, approximately 31.75 mm, between approximately 30.0 mm and approximately 35.0 mm, approximately 34.925 mm, between approximately 35.0 mm and approximately 40.0 mm, and/or less than approximately 40 mm. The second length 702 can be at least approximately 130.0 mm, between approximately 130.0 mm and approximately 200.0 mm, between approximately 130.0 mm and approximately 140.0 mm, approximately 133.35 mm, approximately 139.7 mm, between approximately 140.0 mm and approximately 150.0 mm, approximately 152.4 mm, between approximately 150.0 mm and approximately 160.0 mm, between approximately 160.0 mm and approximately 170.0 mm, approximately 177.8 mm, between approximately 170.0 mm and approximately 180.0 mm, between approximately 180.0 mm and approximately 190.0 mm, approximately 190.5 mm, between approximately 190.0 mm and approximately 200.0 mm, or less than approximately 200.0 mm.

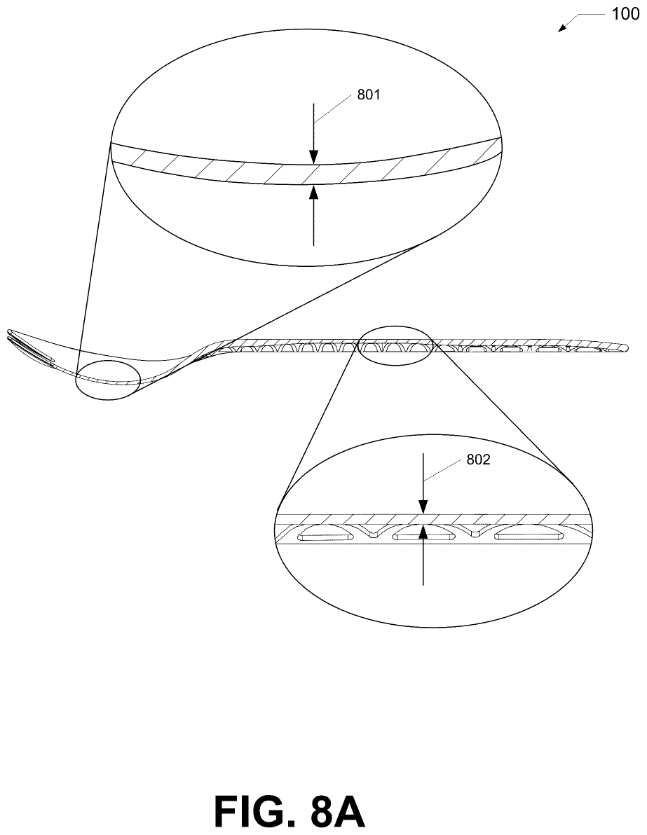

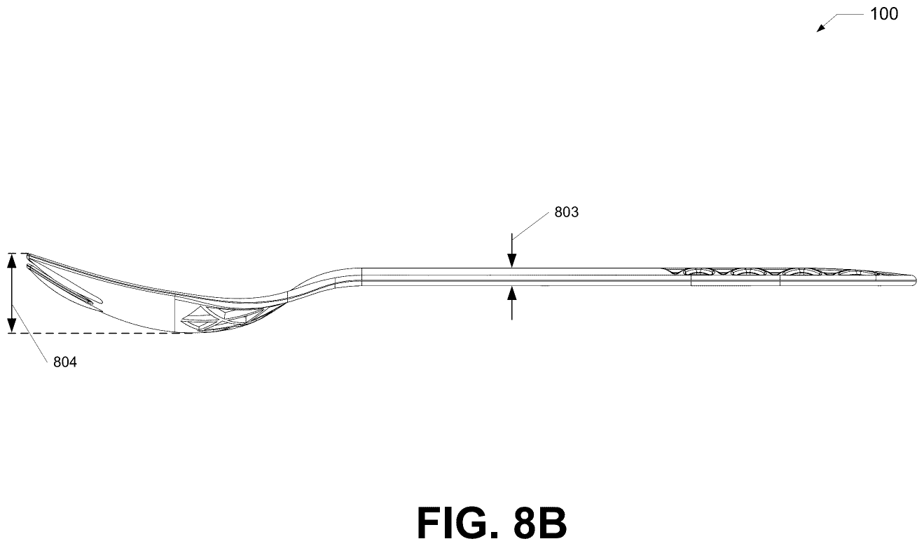

Referring now to FIG. 8A, illustrated is a second cross-sectional view of the utensil 100 taken along the second cut line 121, as well as a magnified view of a portion thereof. The utensil 100 can include a second utility portion thickness 801 and a second handle portion thickness 802. The second utility portion thickness 801 can be at least approximately 0.5 mm, between approximately 0.5 mm and approximately 1.0 mm, between approximately 0.5 mm and approximately 0.7 mm, approximately 0.7 mm, between approximately 0.7 mm and approximately 1.0 mm, or less than approximately 1.0 mm. The second handle portion thickness 802 can be at least about approximately 0.5 mm, between approximately 0.5 mm and approximately 1.5 mm, between approximately 0.5 mm and approximately 1.0 mm, approximately 0.9 mm, between approximately 1.0 mm and approximately 1.5 mm, or less than approximately 1.5 mm. The handle portion 101, the transition portion 102, and/or the utility portion 103 can have varying thicknesses.

Referring now to FIG. 8B, illustrated is a second side view of the utensil 100. The utensil 100 can include a handle portion height 803 and a second utility height 804. The handle portion height 803 can be at least approximately 2.0 mm, between approximately 2.0 mm and approximately 4.0 mm, 2.0 mm and approximately 3.0 mm, approximately 3.0 mm, between approximately 3.0 mm and approximately 4.0 mm, or less than approximately 4.0 mm. The second utility height 804 can be at least approximately 5.0 mm, between approximately 5.0 mm and approximately 20.0 mm, between approximately 5.0 mm and approximately 10.0 mm, between approximately 10.0 mm and approximately 15.0 mm, approximately 13.3 mm, between approximately 15.0 mm and approximately 20.0 mm, or less than approximately 20.0 mm. The second utility height 804 and/or the utility height 403 can differ for different type so utility portions (e.g., spoon configurations, fork configurations, knife configurations).

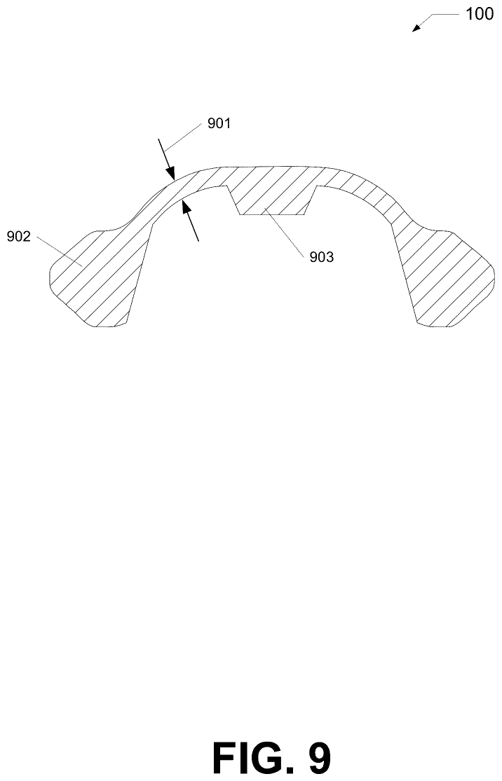

Referring now to FIG. 9, illustrated is a cross-sectional view taken along the first cut line 233. The utensil 100 can include a fourth thickness 901, a second utensil edge 902, and a second bead 903. The fourth thickness 901 can be the thickness of the handle portion 101 and/or the recesses 211. The fourth thickness 901 can be at least about approximately 0.1 mm, between approximately 0.1 mm and approximately 0.6 mm, between approximately 0.1 mm and approximately 0.3 mm, between approximately 0.3 mm and approximately 0.6 mm, approximately 0.4 mm, or less than approximately 0.6 mm. The second utensil edge 902 can include a greater thickness as compared to the utensil edge 311. The second utensil edge 902 can provide greater rigidity to the handle portion 101. The second bead 903 can include the same thickness as the bead 106. The second bead 903 can include angled sidewalls, which can help reduce the amount of material used while still providing the structural benefits of the bead 106.

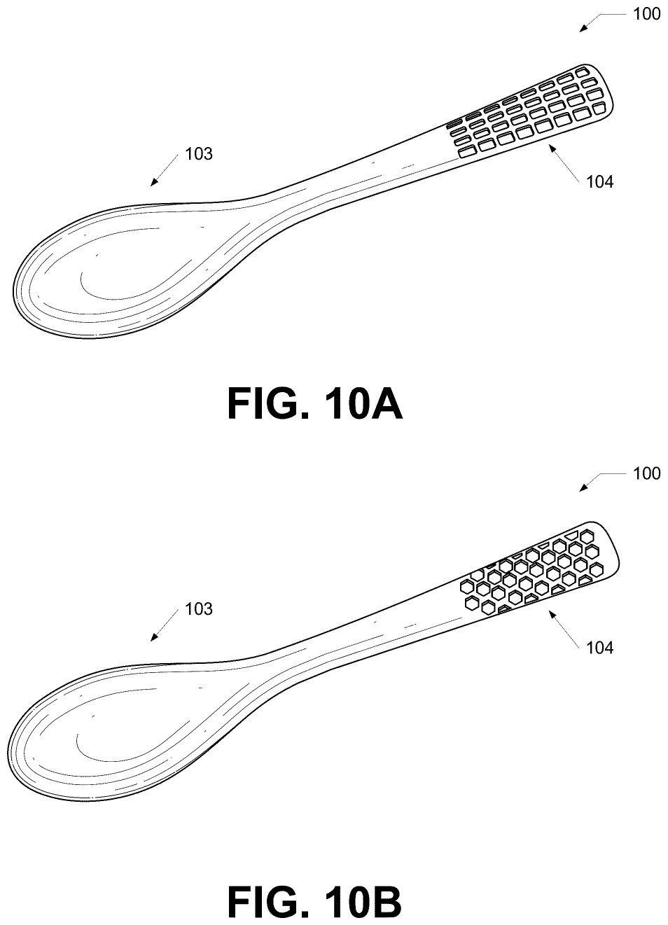

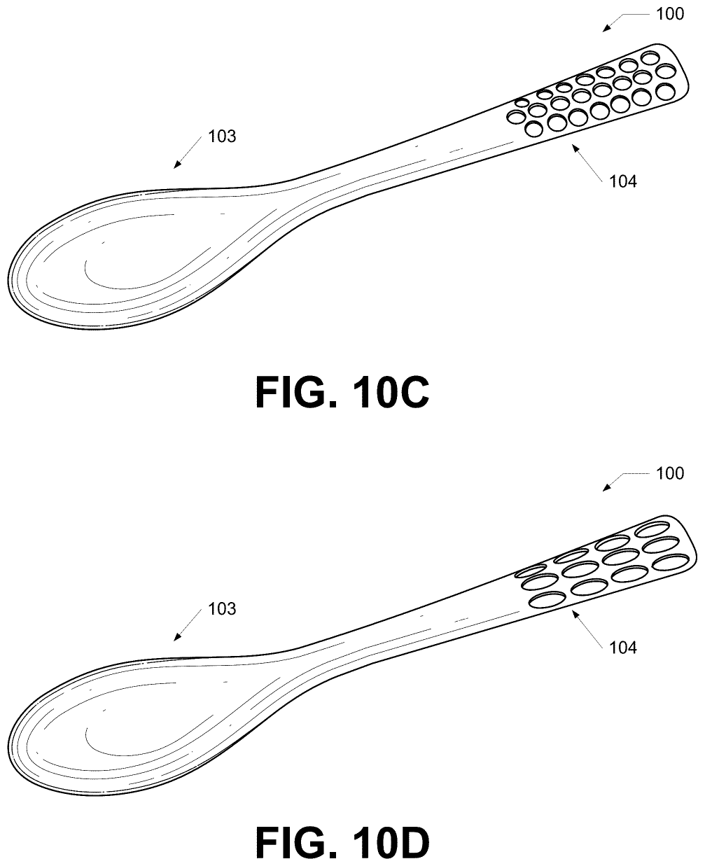

Referring now to FIG. 10A-10D, illustrated are various handle and utility configurations of the utensil 100. As shown in FIG. 10A, the utensil 100 can include the cell frame configuration 104 including one or more rectangular shapes 221. As shown in FIG. 10B, the utensil 100 can include the cell frame configuration 104 including one or more hexagonal shapes 221. As shown in FIG. 10C, the utensil 100 can include the cell frame configuration 104 including one or more circular shapes 221. As shown in FIG. 10D, the utensil 100 can include the cell frame configuration 104 including one or more elliptical shapes 221. The utility portion 103 of the utensil 100 can include a spoon configuration.

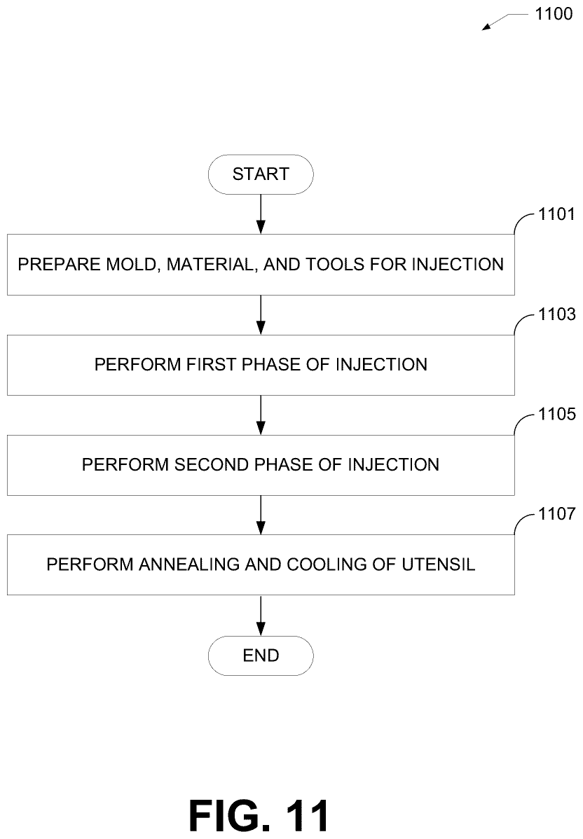

Referring now to FIG. 11, illustrated is a flowchart of an example method or process 1100 for manufacturing, forming, or otherwise creating the utensil 100. At step 1101, the process 1100 can include preparing the mold, the material, and one or more tools for injecting the material into the mold. Preparing the mold can include building or otherwise creating the mold, such as by additive manufacturing practices to create a negative space corresponding to the utensil 100, milling a negative space corresponding to the utensil 100 from a block of material, or any other useful method. The mold can be cooled to a temperature greater than or equal to 10 degrees Celsius (° C.), between approximately 10° C. and approximately 15° C., or less than or equal to approximately 15° C. The utensil 100 can include first and second mold portions, and one or both of the first and second mold portions can be cooled (e.g., using a chiller). An injection molding system can be charged with any particular material (e.g., one or more plastics or other materials as described herein). The injection molding system can be charged with a combination of 82.5% CPLA by mass and 17.5% PBAT by mass. The material can be heated and/or melted in preparation for injection. The injection molding system can include melt temperature parameters, such as and by way of example, a nozzle section temperature of 197° C., a metering section temperature of 200° C., a compression section temperature of 195° C., and a rear feed temperature of 193° C.

At step 1103, the process 1100 can include performing a first phase of an injection into the mold. The first phase of the injection can include partially filling the negative spaces of the mold with the material. The process 1100 can include generating, via the injection molding system, a pressure of approximately 75 bars and/or injecting the material into the mold at approximately 50% of maximum injection speed. The injection molding system can have a set point of approximately 70 mm during the first phase of the injection. The set point can define the end position of a barrel of the injection molding system relative to the mold. For example, the set point can define a position where the barrel cannot move passed relative to the mold. The process 1100 can include injecting the material into the mold and through (or along or via) the negative space of the mold corresponding to the bead 106 of the utensil 100. As explained elsewhere herein, injecting the material into or along the bead 106 can help evenly distribute the material to all parts of the mold to form a complete utensil 100. Alternatively or in addition, the bead 106 can reduce the friction caused when injecting the material into the mold and allow for even distribution of material throughout the mold.

At step 1105, the process 1100 can include performing a second phase of the injection into the mold. The second phase of the injection can include fully fill all portions of the mold. The process 1100 can include generating, via the injection molding system, a pressure of approximately 85 bars and/or injecting the material into the mold at approximately 45% of maximum speed. The injection molding system can have a set point of approximately 45 mm during the second phase of the injection. The second phase of the injection can be performed into the bead 106. In various embodiments, the first phase and the second phase of injection can last a total of less than approximately 1 second (e.g., approximately 0.97 seconds). Once injection of the material into the mold is complete, the process 1100 can include holding a set point at approximately 40 mm for approximately 3 seconds.

At step 1107, the process 1100 can include performing annealing and/or cooling of the utensil 100. The utensil 100 can be annealed at approximately 135° C. for approximately 19 seconds, which can help remove or dissipate internal stresses caused during the molding process. For example, the utensil 100 can be processed through a heat tunnel set to a temperature between approximately 125° C. and approximately 135° C. for at least approximately 1 minute, between approximately 1 minute and approximately 20 minutes, between approximately 1 minute and approximately 4 minutes, between approximately 4 minutes and approximately 4 minutes, between approximately 15 minutes and approximately 20 minutes, or less than approximately 20 minutes, to improve the crystallinity of the utensil 100. The utensil 100 can be reduced in temperature (e.g., cooling with water) for approximately 10 seconds to form the final utensil 100. The annealing and/or cooling processes can be performed in any order relative to one another. The annealing process can help with increasing a crystallization of the utensil 100, and increasing the crystallization of the utensil 100 can increase the heat resistance and/or thermal deformation temperature of the resulting utensil 100.

Referring now to FIG. 12, illustrated is an example mold 1200 for the utensil 100. The mold 1200 can include at least one utensil mold 1201. For example, the mold 1200 can include 16 utensil molds 1201, as depicted. The example mold 1200 can include a first mold portion 1202 and a second mold portion 1203. The first mold portion 1202 can include a top cavity 1204 and the second mold portion 1203 can include a bottom cavity 1205. The top cavity 1204 can include various protrusions and/or recesses that create a top impression of the utensil 100 (e.g., a negative corresponding to a top portion of the utensil 100). The bottom cavity 1205 can include protrusions and/or recesses that create a bottom impression for the utensil 100 (e.g., a negative corresponding to a bottom portion of the utensil 100). The utensil mold 1201 can 1201 can include a negative space corresponding to the bead 106 on the first mold portion 1202 and/or the second mold portion 1203. For example, the negative space corresponding to the bead 106 can extend between a plurality of cell frame configuration protrusions 1206 (which can correspond to a plurality of apertures 111 and/or recess 211 of the utensil 100).

The cell frame configuration protrusions 1206 can vary in height and can be included on both the top cavity 1204 and the bottom cavity 1205, on only the top cavity 1204, or on only the bottom cavity 1205. For example, the top cavity 1204 and bottom cavity 1205 can include oppositely facing (e.g., when the mold 1200 is in a closed position) cell frame configuration protrusions 1206, where the cell frame configuration protrusions 1206 of the top cavity 1204 mate with the cell frame configuration protrusions 1206 of the bottom cavity 1205. Continuing this example, the oppositely facing cell frame configuration protrusions 1206 can reduce or prevent the flow of material in the specified areas to thus generate the recesses 211 or apertures 111. The bottom cavity 1205 can include cell frame configuration protrusions 1206 in areas opposite to a flat surface 1207 of the top cavity 1204. As a non-limiting example, by including cell frame configuration protrusions 1206 in areas of the bottom cavity 1205 opposite to the flat surface 1207 of the top cavity 1204, the mold 1200 can generate the recesses 211 of the utensil 100.

The foregoing description of the exemplary embodiments has been presented only for the purposes of illustration and description and is not intended to be exhaustive or to limit the innovations to the precise forms disclosed. Many modifications and variations are possible in light of the above teaching.

The embodiments were chosen and described in order to explain the principles of the claimed innovations and their practical application so as to enable others skilled in the art to utilize the innovations and various embodiments and with various modifications as are suited to the particular use contemplated. Alternative embodiments will become apparent to those skilled in the art to which the claimed innovations pertain without departing from their spirit and scope. Accordingly, the scope of the claimed innovations is defined by the appended claims rather than the foregoing description and the exemplary embodiments described therein.

What is claimed is:

1. A biodegradable utensil comprising:
a utility portion located at a first end of the utensil, the utility portion being configured to manipulate a food item; and
a handle portion located at a second end of the utensil, the second end being opposite the first end, and the handle portion comprising:
a body having a first thickness;
a plurality of thickness-reducing features located along at least a portion of the body, each of the plurality of thickness-reducing features having a thickness less than the first thickness; and
a bead extending along at least some of a length of the handle portion, the bead (i) being continuous and uninterrupted, (ii) extending between a first thickness-reducing feature of the plurality of thickness-reducing features and a second thickness-reducing feature of the plurality of thickness-reducing features, and (iii) having a second thickness that is greater than the first thickness; and
a transition portion disposed between the handle portion and the utility portion.

2. The biodegradable utensil of claim 1, wherein the utility portion comprises a fork configuration.

3. The biodegradable utensil of claim 1, wherein the utility portion comprises a spoon configuration.

4. The biodegradable utensil of claim 1, wherein the utility portion comprises a spork configuration.

5. The biodegradable utensil of claim 1, wherein the utility portion comprises a knife configuration.

6. The biodegradable utensil of claim 1, wherein the transition portion has a third thickness that is greater than the first thickness.

7. The biodegradable utensil of claim 1, wherein the bead extends along a central longitudinal axis of the utensil.

8. The biodegradable utensil of claim 1, wherein the bead is a first bead and the utensil further comprises a second bead that is continuous and uninterrupted and has the second thickness.

9. The biodegradable utensil of claim 8, wherein at least one of the first bead or the second bead is generally parallel to a central longitudinal axis of the utensil.

10. The biodegradable utensil of claim 1, wherein the second thickness is less than or equal to approximately 0.6 mm.

11. The biodegradable utensil of claim 10, wherein the second thickness is less than or equal to approximately 0.5 mm.

12. The biodegradable utensil of claim 1, wherein a weight of the utensil is less than or equal to approximately 3 grams.

13. A method for manufacturing a biodegradable utensil, the method comprising:
providing a mold comprising a negative space corresponding to a utensil having:
a utility portion located at a first end of the utensil, the utility portion being configured to manipulate a food item; and
a handle portion located at a second end of the utensil, the second end being opposite the first end, and the handle portion comprising:
a body having a first thickness;
a plurality of thickness-reducing features located along at least a portion of the body, each of the plurality of thickness-reducing features having a thickness less than the first thickness; and
a bead extending along at least some of a length of the handle portion, the bead (i) being continuous and uninterrupted, (ii) extending between a first thickness-reducing feature of the plurality of thickness-reducing features and a second thickness-reducing feature of the plurality of thickness-reducing features, and (iii) having a second thickness that is greater than the first thickness; and
a transition portion disposed between the handle portion and the utility portion;
introducing a material into the mold; and
hardening the material to form the utensil.

14. The method of claim 13, wherein introducing the material into the mold comprises:
performing a first injection phase comprising injecting a first amount of the material at a pressure of approximately 75 bars.

15. The method of claim 14, wherein the first injection phase comprises injecting the first amount of the material at a set point of approximately 70 mm from a zero-point, the zero-point being a position at which a barrel of a corresponding material injection system is unable to move any nearer the mold.

16. The method of claim 14, wherein introducing the material into the mold further comprises:
performing a second injection phase comprising injecting a second amount of the material at a pressure of approximately 85 bars.

17. The method of claim 16, wherein the second injection phase comprises injecting the second amount of the material at a set point approximately at a zero-point, the zero-point being a position at which a barrel of a corresponding material injection system is unable to move any nearer the mold.

18. The method of claim 13 further comprising:
subsequent fully filling the negative space of the mold with the material, holding the material in the mold for a holding time of approximately 3 seconds.

19. The method of claim 13, wherein hardening the material comprises:
annealing the material at approximately 135° C. for approximately 19 seconds.

20. The method of claim 13, wherein hardening the material comprises:
running cooling the material by flowing a refrigerant through one or more refrigerant flow paths through the mold for a cooling time of approximately 10 seconds.
